(19) United States
(12) Patent Application Publication
(10) Pub. No.: US 2026/0241861 A1
(43) Pub. Date: Aug. 20, 2026

(54) SYSTEM AND METHOD OF OPERATING A VEHICLE WITH A WINCH

(71) Applicant: GM GLOBAL TECHNOLOGY OPERATIONS LLC, Detroit, MI (US)

(72) Inventors: Brian K. Saylor, South Lyon, MI (US); Robert D. Garbee, Berkley, MI (US); Toure Lee, Pontiac, MI (US)

(73) Assignee: GM GLOBAL TECHNOLOGY OPERATIONS LLC, Detroit, MI (US)

(21) Appl. No.: 19/055,824

(22) Filed: Feb. 18, 2025

(51) Int. Cl. B60Q 9/00

(52) U.S. Cl. CPC B60Q 9/00

(57) ABSTRACT

A method of operating a vehicle with a winch includes utilizing at least one sensor on the vehicle to obtain at least one image of a winch cable when the winch cable is unspooled from the winch. A location of the winch cable is tracked within the at least one image and a cable setback zone is determined for the winch cable when the winch cable is respooling with a winch motor. The method also includes identifying at least one object relative to the cable setback zone within the at least one image and determining an alert based on a type and a location of the at least one object relative to the cable setback zone when the winch cable is respooling.

### BACKGROUND

The present disclosure relates to a vehicle with a winch, and more particularly, to monitoring operation of the winch.

Vehicle recovery operations frequently involve the use of winches to extract vehicles that have become immobilized due to adverse terrain conditions or mechanical failures. In off-road environments, vehicles frequently encounter situations where standard locomotion becomes impossible due to factors such as deep mud, snow, sand, or steep inclines. Traditional recovery methods, such as towing or pushing, often prove inadequate in these scenarios due to limited access, unstable ground conditions, or the risk of causing additional damage to the vehicle. Winching has emerged as a preferred solution due to its ability to provide controlled, steady force application while maintaining a safe distance between the recovery vehicle and the stranded vehicle.

Current winching systems typically include several key components: an electric or hydraulic motor, a drum assembly, a steel or synthetic rope, and various attachment points and accessories. These systems are commonly mounted on the front or rear of vehicles, particularly on specialized recovery vehicles and off-road capable vehicles. The effectiveness of a winch system depends not only on its raw pulling capacity but also on factors such as the angle of pull, rope length, and the strategic use of ancillary equipment such as snatch blocks and tree protectors.

### SUMMARY

Disclosed herein is a method of operating a vehicle with a winch. The method includes utilizing at least one sensor on the vehicle to obtain at least one image of a winch cable when the winch cable is unspooled from the winch. A location of the winch cable is tracked within the at least one image and a cable setback zone is determined for the winch cable when the winch cable is respooling with a winch motor. The method also includes identifying at least one object relative to the cable setback zone within the at least one image and determining an alert based on a type and a location of the at least one object relative to the cable setback zone when the winch cable is respooling.

In one aspect of the disclosure the at least one sensor includes an optical sensor.

In one aspect of the disclosure the cable setback zone defines a three-dimensional space surrounding the winch cable.

In one aspect of the disclosure the method includes displaying the at least one image from the sensor on a vehicle display and highlighting a location of the cable setback zone in the at least one image.

In one aspect of the disclosure the method includes issuing the alert when the location of the at least one object is within the cable setback zone and the type of the at least one object includes a pedestrian.

In one aspect of the disclosure the alert includes deactivating the winch motor to stop the winch cable from respooling.

In one aspect of the disclosure the alert includes highlighting the at least one object within the cable setback zone on a vehicle display.

In one aspect of the disclosure the alert includes one of an audible indicator or a visual indicator.

In one aspect of the disclosure the alert includes displaying a message on a vehicle display.

In one aspect of the disclosure the winch cable is respooling when a current applied to the winch motor exceeds a predetermined threshold current.

In one aspect of the disclosure the location of the winch cable is tracked with an object detection algorithm.

Disclosed herein is a non-transitory computer-readable storage medium embodying programmed instructions which, when executed by a processor, are operable for performing a method. The method includes utilizing at least one sensor on the vehicle to obtain at least one image of a winch cable when the winch cable is unspooled from the winch. A location of the winch cable is tracked within the at least one image and a cable setback zone is determined for the winch cable when the winch cable is respooling with a winch motor. The method also includes identifying at least one object relative to the cable setback zone within the at least one image and determining an alert based on a type and a location of the at least one object relative to the cable setback zone when the winch cable is respooling.

In one aspect of the disclosure the cable setback zone defines a three-dimensional space surrounding the winch cable.

In one aspect of the disclosure the method includes issuing the alert when the location of the at least one object is within the cable setback zone and the type of the at least one object includes a pedestrian.

In one aspect of the disclosure the alert includes deactivating the winch motor to stop the winch cable from respooling.

In one aspect of the disclosure the alert includes highlighting the at least one object within the cable setback zone on a vehicle display.

In one aspect of the disclosure the alert includes one of an audible indicator, a visual indicator, or a message on a vehicle display.

Disclosed herein is a vehicle. The vehicle includes a passenger cabin supported by wheels, a winch including a winch cable and a winch motor configured to unspool or respool the winch cable, and an optical sensor associated with the vehicle having a field of view surrounding the vehicle, and a controller in electrical communication with the winch and the optical sensor. The controller is configured to utilize the optical sensor to obtain at least one image of the winch cable when the winch cable is unspooling and track a location of the winch cable within the at least one image with an object tracking algorithm. The method is also configured to determine a cable setback zone for the winch cable when the winch motor is activated to respool the winch cable into the winch and identify at least one object relative to the cable setback zone within the at least one. With the cable setback zone, the controller is configured to determine an alert based on a type and a location of the at least one object relative to the cable setback zone when the winch cable is respooling.

In one aspect of the disclosure the controller is configured to issue the alert when the location of the at least one object is within the cable setback zone and the type of the at least one object includes a pedestrian.

In one aspect of the disclosure the alert includes at least one of deactivating the winch motor to stop the winch cable from respooling or highlighting the at least one object within the cable setback zone on a vehicle display within the passenger cabin.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates a vehicle with a winch and a sensor.

FIG. 2 is a flow chart of an example method of operating the winch in connection with the vehicle of FIG. 1.

FIG. 3 schematically illustrates an image obtained from a sensor on the vehicle of FIG. 1 showing an example cable setback zone.

FIG. 4 schematically illustrates an image obtained from the sensor on the vehicle of FIG. 1 showing another example cable setback zone.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

While operating a vehicle, especially in an off road situation, it is possible for the vehicle to become stuck and no longer be able to generate momentum in either a forward or reverse direction. In these situations, the vehicle may need to be pulled from its current location to overcome an obstacle or reach an area with improved traction. For vehicles equipped with a winch, the vehicle may be able to perform a self-recovery by attaching a winch cable to an anchor, such as another vehicle or an immobile object. The winch includes an electric motor powered by the vehicle or a remote power source that will retract or spool the winch cable into the winch. The winch can then pull the vehicle from its current location to a new location where the vehicle will be able to continue under its own power.

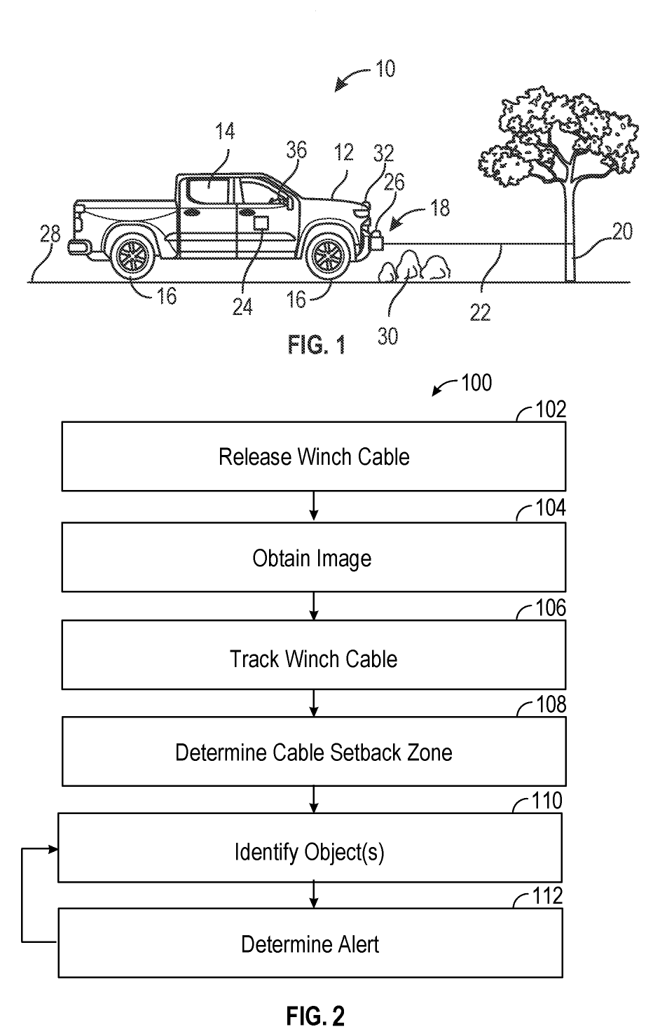

As shown in FIG. 1, the vehicle 10 includes a body 12 that at least partially defines a passenger cabin 14 and is supported by wheels 16 configured to engage a road surface 28. In the illustrated example, the vehicle 10 is illustrated as a truck, however, this disclosure applies to other vehicle types, such as sport utility vehicles (SUV) or other off-road related vehicles. The vehicle 10 is also equipped with a winch 18 having a winch cable 22 driven by a winch motor 26 to respool the winch cable 22 and pull the vehicle 10 over obstacles 30 in the path of the vehicle 10. Operation of the vehicle 10 and the winch 18 is at least partially controlled by a controller 24 configured to at least partially perform a method 100 of operating the winch 18 described below. A vehicle display 36 is located within the passenger cabin 14 for displaying information to the occupants of the vehicle 10.

The electronic controller 24 is disposed in communication with the sensor(s) 32 on the vehicle 10 for receiving their respective sensed data related to the surroundings of the vehicle 10. The electronic controller 24 may alternatively be referred to as a control module, a control unit, a controller, a vehicle 10 controller, a computer, etc. The electronic controller 24 may include a computer and/or processor, and include software, hardware, memory, algorithms, connections (such as the sensor(s) 32), etc., for managing and controlling the operation of the vehicle 10. As such, a method, described below and generally represented in FIG. 2, may be embodied as a program or algorithm partially operable on the electronic controller 24. It should be appreciated that the electronic controller 24 may include a device capable of analyzing data from the sensor(s) 32, comparing data, making the decisions required to control the operation of the vehicle 10, and executing the required tasks to control the operation of the vehicle 10.

The electronic controller 24 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 24 includes a tangible, non-transitory memory on which computer-executable instructions, including one or more algorithms, are recorded for regulating operation of the motor vehicle 10.

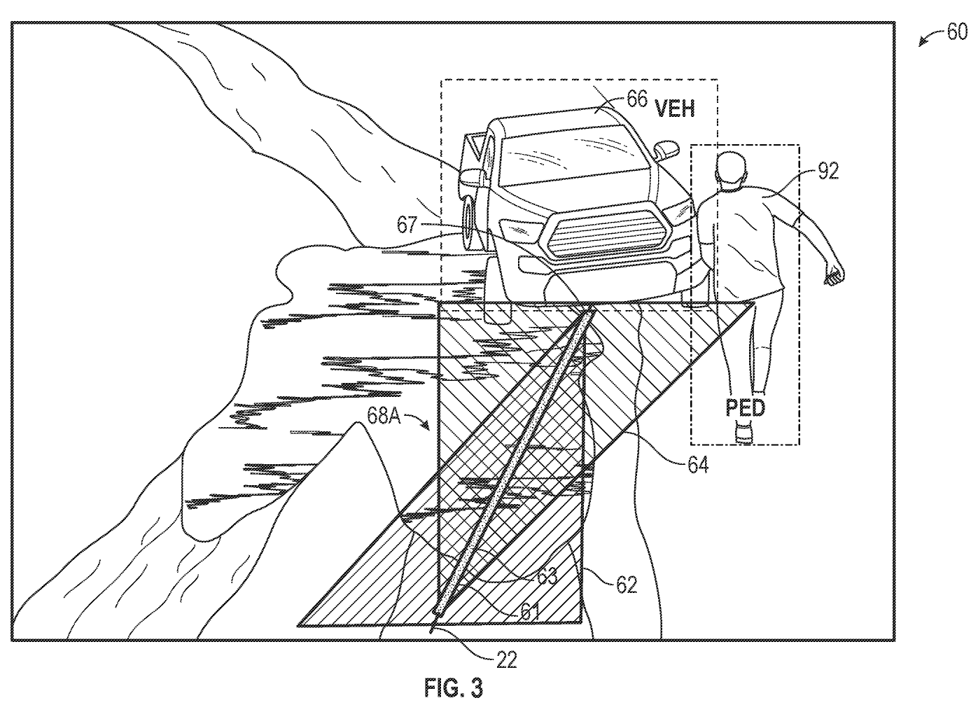

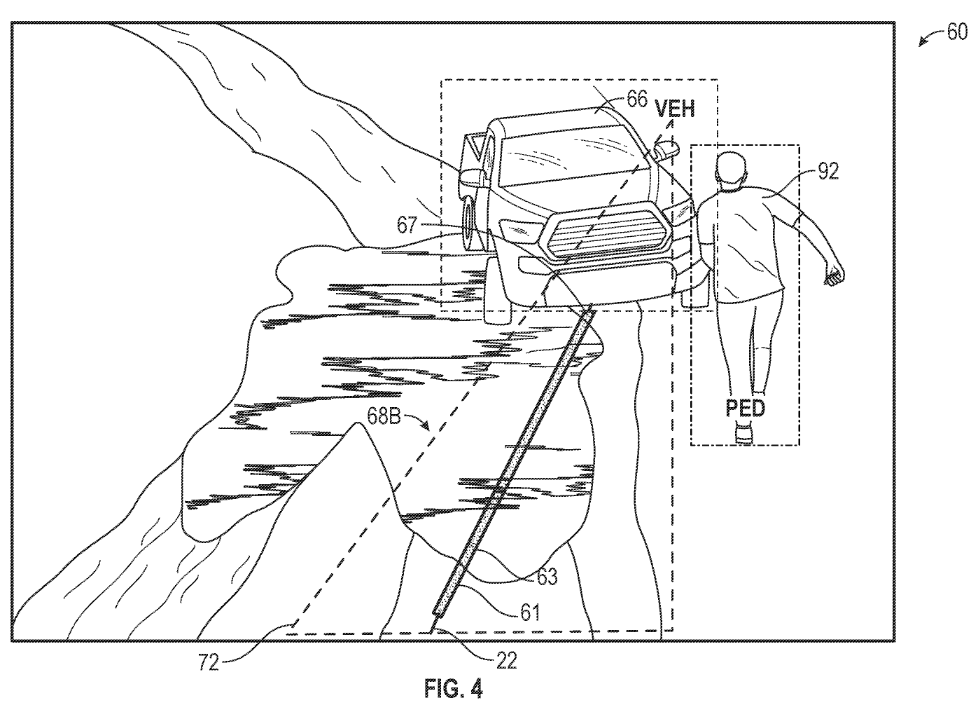

FIG. 2 illustrates a flowchart of the method 100 of operating the winch on the vehicle 10. The method 100 beings as block 102. At block 102 (“Release Winch Cable”), the winch cable 22 is released or unspooled from the winch 18. When the winch cable 22 is released, the winch cable 22 can be unspooled from the winch 18 and attached to an anchor 20 (FIG. 1) or another vehicle (FIGS. 3-4). Furthermore, while the illustrated example of FIG. 1 shows the vehicle 10 winching itself relative to the anchor 20 with the anchor being fixed from moving, the vehicle 10 can operate as an anchor to pull another vehicle 66 with the winch cable 22 (FIGS. 3-4). When the winch cable 22 is at least partially unspooled from the winch 18, the method 100 proceeds to block 104.

At block 104 (“Obtain Image”), a sensor 32 on the vehicle 10, such as a forward facing optical camera, radar, or lidar, is utilized to obtain at least one image of the winch cable 22 in an unspooled position. For example, the at least one image can include a series of images illustrating operation of the winch 18 from the winch cable 22 initially unspooling from the winch 18 to the winch cable 22 being respooled into the winch 18. The sensor 32 is positioned to include a field of view that includes the winch cable 22 on the front of the vehicle 10. FIGS. 3 and 4 illustrate an example image 60 obtained by the at least one sensor 32. In one example, the at least one image 60 can be shown in the vehicle display 36 on the vehicle 10.

While the winch 18 is shown in a front of the vehicle 10 in the illustrated example of FIG. 1, the winch 18 could be located on other portions of the vehicle 10. For example, the winch 18 could be located at a rear of the vehicle 10 and sensor 32 could include a rear view camera having a field of view of the winch 18 located at the rear of the vehicle 10. With the at least one image obtained, the method 100 proceeds to block 106.

At block 106 (“Track Winch Cable”), the method 100 tracks a location of the winch cable 22 in the at least one image obtained in block 104. In one example, the method 100 utilizes an object tracking algorithm to identify a location of the winch cable 22 in the at least one image 60. To aid in identifying the winch cable 22 in the at least one image 60, a color of the winch cable 22 can be input into the object tracking algorithm to aid in identifying the winch cable 22 in the image 60. For example, the winch cable 22 could include a high contrast color, such as neon green, to improve the ability of the object tracking algorithm to identify the winch cable 22 in the at least one image.

If the location of the winch cable 22 is unable to be determined from the at least one image 60 when the winch cable 22 is unspooled, this could indicate that the sensor 32 is obstructed, such as by mud or tree limbs. The method 100 can issue an alert to inspect the sensor 32 for obstruction in order for object tracking algorithm to identify the winch cable 22. In one example, the alert can be displayed on the vehicle display 36 on a dash in the passenger cabin 14 of the vehicle 10. Once the sensor 32 is provided a clear view of the winch cable 22, the winch cable 22 can be tracked by the object tracking algorithm, such as OpenCV, DeepSORT, or another object tracking algorithm.

Furthermore, while the at least one image 60 is being shown on the vehicle display 36, the winch cable 22 could be highlighted such as with a high contrast color 61 (shown as texturing in FIGS. 3-4) or a bounding box 63, to aid the operator of the vehicle 10 to more easily identify the location of the winch cable 22 in the image 60. With the winch cable 22 being tracked, the method 100 proceeds to block 108.

At block 108 (“Determine Cable Setback Zone”), the method 100 determines a cable setback zone relative to the winch cable 22. The cable setback zone defines a region, such as a region in three-dimensional (3D) space surrounding the winch cable 22 that should remain clear of certain object types during operation of the winch 18.

For example, an operator of the vehicle 10 or another person around the vehicle 10 may unspool the winch cable 22 from the winch 18 during operation. In this situation, while the winch cable 22 is not under a load or being respooled by the winch motor 26, the person may be directly engaging the winch cable 22 to help guide the winch cable 22. However, when the winch cable 22 is under tension, such as when the winch motor 26 is respooling the winch cable 22, the method 100 determines a cable setback zone that should be free of objects of a certain type, such as pedestrians, while the winch cable 22 is under load or being respooled.

Furthermore, the method 100 can differentiate between when the winch cable 22 is being respooled versus under tension pulling the vehicle 10 by monitoring current being supplied to the winch motor 26. For example, the method 100 can determine that an object of a certain type should not be located within the cable setback zone when a current level sent to the winch motor 26 exceeds a predetermined threshold current level. In one example, the predetermined threshold current level corresponds to a level greater than the current needed to simply respool the winch cable 22 back within the winch 18.

FIGS. 3 and 4 illustrate two example cable setback zones for the image 60. As shown In FIG. 3, a first triangle 62 extends from the front of the vehicle 10 to a winch attachment point 67 on another vehicle 66. Similarly, a second triangle 64 extends from the winch attachment point 67 to the front of the vehicle 10. In this example, a cable setback zone 68A can include the location of the first and second triangles 62 and 64 or the location of the intersection of the first and second triangles 62 and 64. Furthermore, while the image 60 is a two-dimensional image and the first and second triangles 62 and 64 are illustrated in as two-dimensional objects in the image 60, but for purposes of identifying an object within the cable setback zones 68A, 68B, the first and second triangles 62 and 64 represent a conical shape in three-dimensions space that extends along a central longitudinal axis that coincides with the winch cable 22.

FIG. 4 illustrates another example cable setback zone 68B for the image 60. In the illustrated example of FIG. 4, a triangle 72 extends from the front of the vehicle 10 a point extending at least two times a distance of the winch cable 22 following a trajectory of the winch cable 22. Similar to FIG. 3 above, the triangle 72 illustrates a cable setback zone 68B. Furthermore, due to the two-dimensional limitations of the image 60 the triangle 72 is represented in two dimensions. However, for purposes of identifying an object within the cable setback zone 68B, the triangle represents a conical shape in three-dimensions space that extends along a central longitudinal axis that coincides with the winch cable 22.

In yet another example, the triangle 72 could extend to a point at infinity such that the opposing sides of the triangle 72 are essentially parallel and form a cylinder in three-dimensional space around the winch cable 22. With the cable setback zone determined, the method 100 proceeds to block 110.

At block 110 (“Identify Object(s)”), the method 100 utilizes the object detection algorithm to identify other objects in the image 60 captured by the sensor 32 beside the winch cable 22. For example, as shown in FIGS. 3 and 4, the object detection algorithm may identify another vehicle 66 or a pedestrian 92 in the image 60. With the objects in the image 60 identified, the method 100 proceeds to block 112.

At block 112 (“Determine Alert”), the method 100 determines if an alert should be issued regarding operation of the winch 18. The method 100 determines if the alert should be issued based on a type of the object and a location of the object relative to the cable setback zones 68A, 68B. For example, if the object detected is a pedestrian and at least a portion of the pedestrian was located within the cable setback zones 68A, 68B, the method 100 could determine that an alert should be issued.

If the method 100 determines that the alert should be issued, the method 100 can produce the alert in several different manners. In one example, the alert could include directing the vehicle 10 to activate a horn (audible indicator) or flash external lights (visual indicator) to notify the pedestrian 92 of his or her location with respect to the cable setback zones 68A, 68B. In another example, the method 100 could deactivate the winch motor 26 by terminating power to the winch motor 26 or unspool the winch cable 22 to release tension in the winch cable 22. In yet another example, the method 100 can provide a message on the vehicle display 36 that a pedestrian is located in the cable setback zones 68A, 68B. Furthermore, the method 100 can highlight the pedestrian 92 or other objects in the image 60 with bounding boxes and display the highlighted version of the image 60 on the vehicle display 36. Accordingly, the method 100 can return to block 110 to continue monitoring for objects relative to the cable setback zone.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating a vehicle with a winch, the method comprising:
utilizing at least one sensor on the vehicle to obtain at least one image of a winch cable when the winch cable is unspooled from the winch;
tracking a location of the winch cable within the at least one image;
determining a cable setback zone for the winch cable when the winch cable is respooling with a winch motor;
identifying at least one object relative to the cable setback zone within the at least one image; and
determining an alert based on a type and a location of the at least one object relative to the cable setback zone when the winch cable is respooling.

2. The method of claim 1, wherein the at least one sensor includes an optical sensor.

3. The method of claim 1, wherein the cable setback zone defines a three-dimensional space surrounding the winch cable.

4. The method of claim 1, including displaying the at least one image from the sensor on a vehicle display and highlighting a location of the cable setback zone in the at least one image.

5. The method of claim 1, including issuing the alert when the location of the at least one object is within the cable setback zone and the type of the at least one object includes a pedestrian.

6. The method of claim 5, wherein the alert includes deactivating the winch motor to stop the winch cable from respooling.

7. The method of claim 5, wherein the alert includes highlighting the at least one object within the cable setback zone on a vehicle display.

8. The method of claim 5, wherein the alert includes one of an audible indicator or a visual indicator.

9. The method of claim 5, wherein the alert includes displaying a message on a vehicle display.

10. The method of claim 1, wherein the winch cable is respooling when a current applied to the winch motor exceeds a predetermined threshold current.

11. The method of claim 1, wherein the location of the winch cable is tracked with an object detection algorithm.

12. A non-transitory computer-readable storage medium embodying programmed instructions which, when executed by a processor, are operable for performing a method comprising:
utilizing a sensor on a vehicle to obtain at least one image of a winch cable when a winch cable is unspooled from a winch;
tracking a location of the winch cable within the at least one image;
determining a cable setback zone for the winch cable when the winch cable is respooling with a winch motor;
identifying at least one object relative to the cable setback zone within the at least one image; and
determining an alert based on a type and a location of the at least one object relative to the cable setback zone when the winch cable is respooling.

13. The medium of claim 12, wherein the cable setback zone defines a three-dimensional space surrounding the winch cable.

14. The medium of claim 12, wherein the method includes issuing the alert when the location of the at least one object is within the cable setback zone and the type of the at least one object includes a pedestrian.

15. The medium of claim 14, wherein the alert includes deactivating the winch motor to stop the winch cable from respooling.

16. The medium of claim 14, wherein the alert includes highlighting the at least one object within the cable setback zone on a vehicle display.

17. The medium of claim 14, wherein the alert includes one of an audible indicator, a visual indicator, or a message on a vehicle display.

18. A vehicle comprising:
a passenger cabin supported by a plurality of wheels;
a winch including a winch cable and a winch motor configured to unspool or respool the winch cable;
an optical sensor associated with the vehicle having a field of view surrounding the vehicle; and
a controller in electrical communication with the winch and the optical sensor, wherein the controller is configured to:
utilize the optical sensor to obtain at least one image of the winch cable when the winch cable is unspooling;
track a location of the winch cable within the at least one image with an object tracking algorithm;
determine a cable setback zone for the winch cable when the winch motor is activated to respool the winch cable into the winch;
identify at least one object relative to the cable setback zone within the at least one; and
determine an alert based on a type and a location of the at least one object relative to the cable setback zone when the winch cable is respooling.

19. The vehicle of claim 18, wherein the controller is configured to issue the alert when the location of the at least one object is within the cable setback zone and the type of the at least one object includes a pedestrian.

20. The vehicle of claim 19, wherein the alert includes at least one of deactivating the winch motor to stop the winch cable from respooling or highlighting the at least one object within the cable setback zone on a vehicle display within the passenger cabin.
